(19) United States
(12) Patent Application Publication
(10) Pub. No.: US 2012/0020725 A1
(43) Pub. Date: Jan. 26, 2012

(54) FURNITURE CONNECTOR

(76) Inventor: CHIA-YU LIU, Taipei (TW)

(21) Appl. No.: 12/841,180

(22) Filed: Jul. 22, 2010

(51) Int. Cl. F16B 9/00

(52) U.S. Cl. 403/260

(57) ABSTRACT

A furniture connector includes a main body and a bolt. The bolt has a positioning portion, and the main body has a bolt hole. An expending chamber is formed to the bolt hole. At least one tooth is formed to a wall of the expending chamber. The at least one tooth serves to engage the positioning portion of the bolt while the bolt is inserted into the bolt hole. A secure connection is achieved fast and efficiently without the screws.

### FIELD OF THE INVENTION

The present invention relates to a connector, and particular to a furniture connector for assembling furniture without the screws.

### DESCRIPTION OF THE PRIOR ART

Known methods for assembling home furniture are generally sorted by the following types.

1. The most traditional method is through nails. While using nails on wooden gear, the heads of the nails remaining on the surface are unfavorable to the smoothness and the appearance. The nail could rust and it is not easy while a disassembly is needed.

2. A better method for improving surface smoothness than the nails is through drilling screws and caps. However, the process is time-consuming and laborious. The appearance is also damaged while the caps for covering the screws are missing.

3. The most popular connector is a cam with a connecting bolt as shown in FIG. 1. But the connection is not stable for the cams are easily rocked. Usually the cams have different color with wood so that an unity of the product is influenced.

4. A method by using wooden tenon and glue is also a traditional method for assembling wooden gear. The firmness of the method is not enough especially for the gluing.

Additionally, a connecting sheet as shown in FIG. 2 is provided. It is hard to be applied to furniture assembling by it's thickness.

A China patent of no. ZL200410017980 disclose a wooden stairs assembly. A step plate, standing plate, and beam plate of the stairs are assembled by a connector having a singular through recess. The step plates with the connectors are connected to connecting bolts fixed to the standing plates and the beam plates in advanced.

The connector has a plurality of screw holes on it, and the connector is fixed to a recess formed to a bottom side of the step plate through screws and the screw holes. Each step plate will need at least two connectors and usually four are needed. Normally each connector has three screw holes so that the assembling is such low efficiency.

Also, the contact surfaces of the connector and the connecting bolt are smooth, the relative position between the connector and the connecting bolt will be influenced or loosened by violations or external forces so that the firmness and the safety of the assembly is also influenced.

Therefore, the assembling of home furniture and its derivative issues still has to be improved and corrected.

### SUMMARY OF THE PRESENT INVENTION

Accordingly, the primary object of the present invention is to provide a furniture connector for efficiently and securely assembling furniture without the screws and safety concern.

To achieve above object, the present invention provides a A furniture connector comprising: a main body having a bolt hole for receiving a bolt; the bolt having a positioning portion and a connecting portion; the positioning portion being received by the bolt hole of the main body; wherein the bolt hole is vertically extended from a top to a bottom of the main body; the positioning hole further has at least one expanding chamber radially extending from the wall of the positioning hole; at least one tooth is formed to the a wall of the expanding chamber to engage the positioning portion of the bolt; the main body and the bolt are inserted into a first recess and a second recess of furniture plates respectively.

### BRIEF DESCRIPTION OF THE DRAWINGS

FIG. 1 is a schematic view showing a connection using a cam of a prior art.

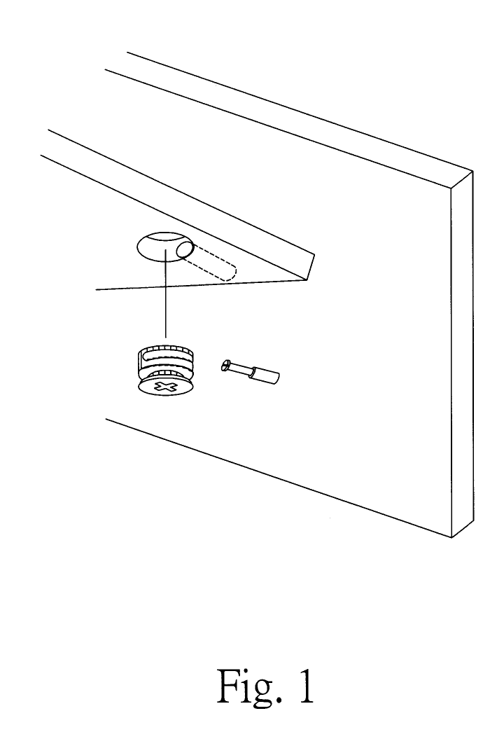

FIG. 2 is a schematic view showing a connecting plate of a prior art.

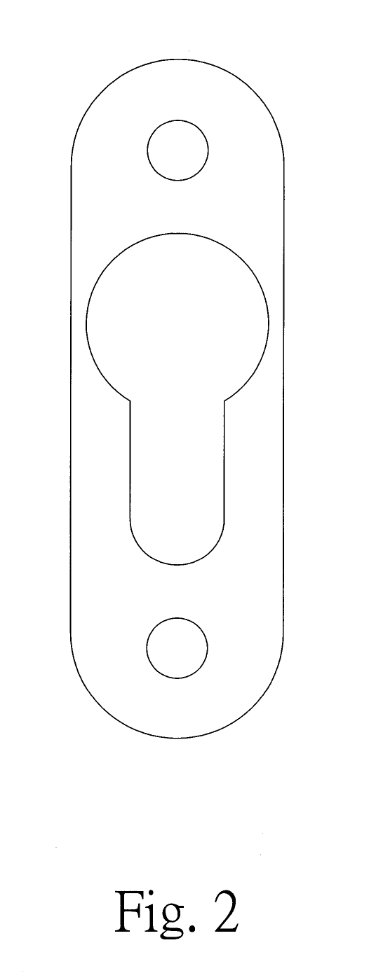

FIG. 3 is a schematic view showing the present invention.

FIG. 4 is a cross-section view showing a main body of the present invention.

FIG. 5 is a schematic view showing a bolt of the present invention.

FIG. 6 is a schematic view showing a disassembly of a first embodiment of the present invention.

FIG. 7 is a schematic view showing an assembly of the first embodiment of the present invention.

FIG. 8 is a schematic view showing an assembly of a second embodiment of the present invention.

FIG. 9 is a schematic view showing a third embodiment of the present invention.

FIG. 10 is a schematic view showing a fourth embodiment of the present invention.

FIG. 11 is a schematic view showing a fifth embodiment of the present invention.

FIG. 12 is a schematic view showing a sixth embodiment of the present invention.

FIG. 13 is a schematic view showing a seventh embodiment of the present invention.

FIG. 14 is a schematic view showing a eighth embodiment of the present invention.

FIG. 15 is a schematic view showing various types of teeth of the present invention.

### DETAILED DESCRIPTION OF THE IVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

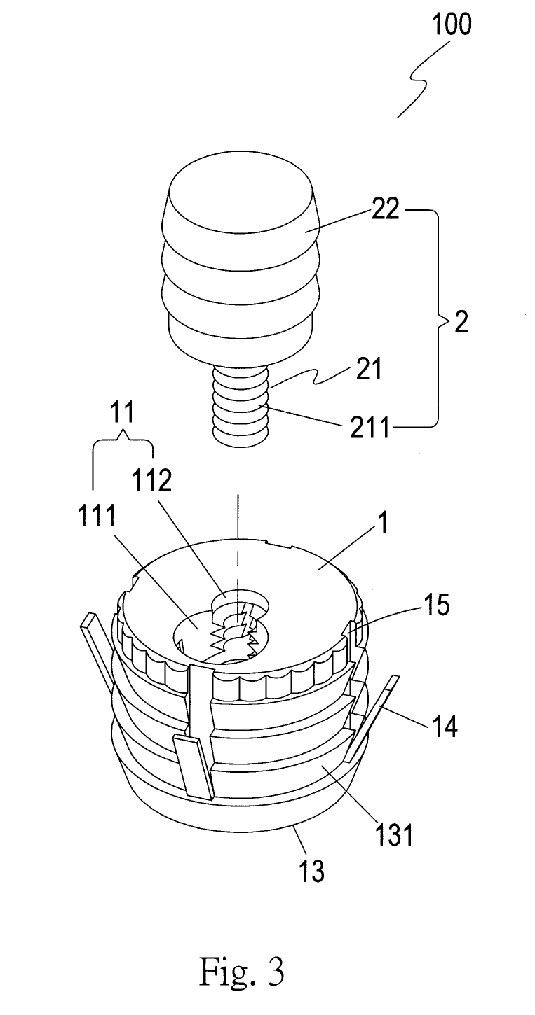

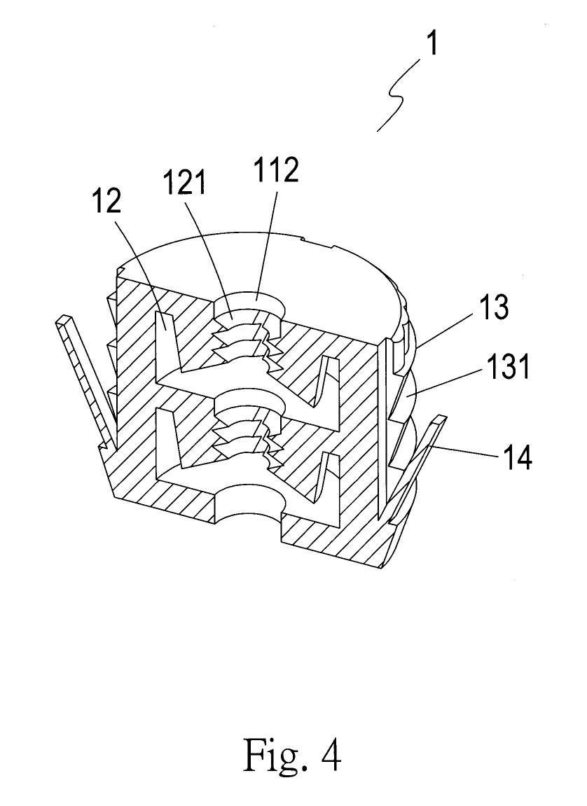

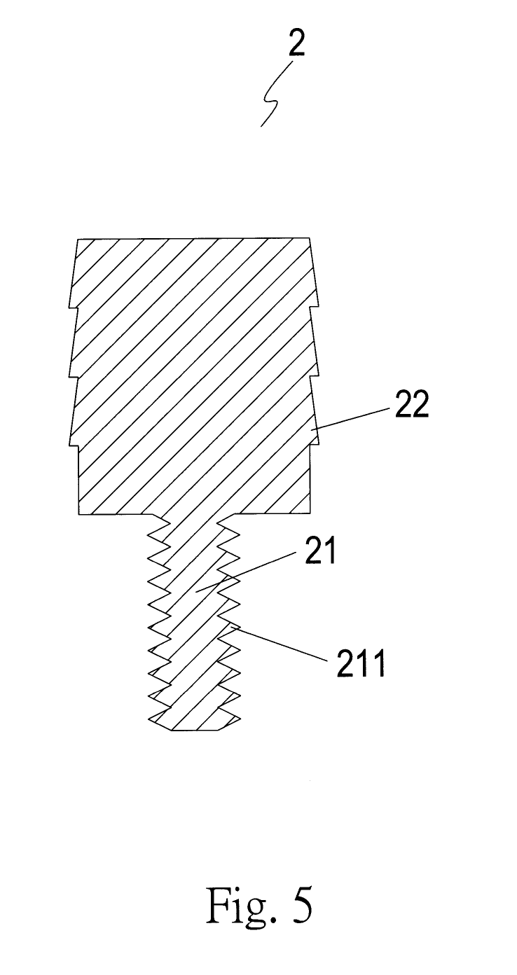

Referring to FIGS. 3 to 5, a furniture connector according to the present invention is illustrated. A furniture connector 100 includes a main body 1 and a bolt 2. The main body 1 has a bolt hole 11 for receiving and fixing the bolt 2.

The bolt 2 has a positioning portion 21 and a connecting portion 22 on two ends thereof. The positioning portion 21 has a plurality of teeth 211, and the connecting portion 22 has sawteeth on a peripheral thereof The bolt hole 11 includes an open hole 111 and a positioning hole 112 vertically extending from a top to a bottom of the main body 1. The open hole 111 serves to release the bolt 2, and the positioning hole 112 serves to engage the bolt 2. The positioning hole 112 further has at least one expanding chamber 12 horizontal extending from a wall of the positioning hole 112. At least one tooth 121 is formed to a wall of the expanding chamber 12 to engage the positioning portion 21 of the bolt 2.

A saw-toothed surface 13 is formed to an outer surface of the main body 1. The saw-toothed surface 13 has a plurality of sawtooth 131. The saw-toothed surface 13 further has two elastic bars 14 and two pairs of positioning mark 15 so that the main body 1 is easily to be installed and positioned. However, the elastic bars and the positioning marks can be removed depending on actual usage by the user.

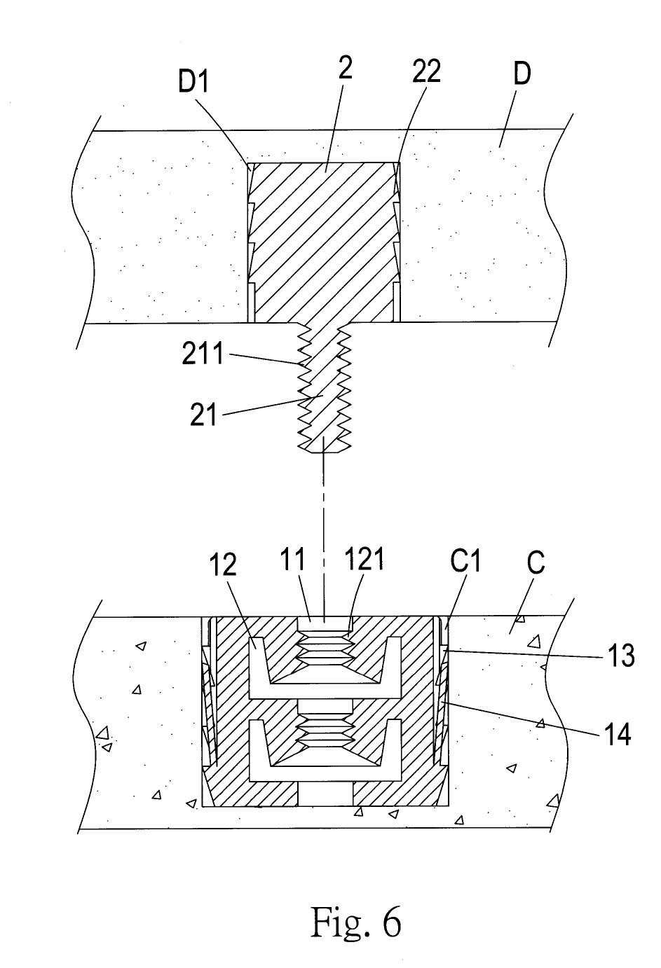

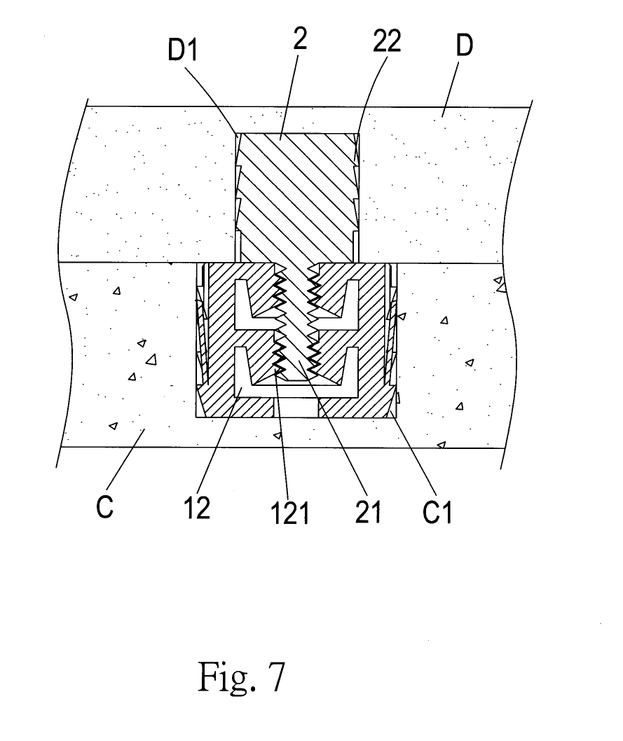

Referring to FIGS. 6 and 7, a first embodiment of the present invention is illustrated. A main body 1 is embedded in a first recess C1 of a first plate C and the connecting portion 22 of the bolt 2 is embedded in a second recess D1 of a second plate D.

While the main body 1 is embedded in the first recess C1 of the plate C, the main body 1 will be easily positioned and tightly secured in the first recess C1 by the saw-toothed surface 13 and the elastic bars 14. The bolt 2 is also secured in the second recess D1 by its connecting portion 22. Therefore, the positioning portion 21 of the bolt 2 can be put into the bolt hole 11 of the main body 1. The at least one tooth 121 of the expanding chamber 12 will engage the teeth 211 formed to the positioning portion 21 of the bolt 2 so that the first plate C and the second plate D will be tightly assembled. While disassembling, the bolt 2 is pushed from the positioning hole 112 to the bigger open hole 111 so that the bolt 2 can be ejected from the bolt hole 2. The bolt 2 is a long bolt.

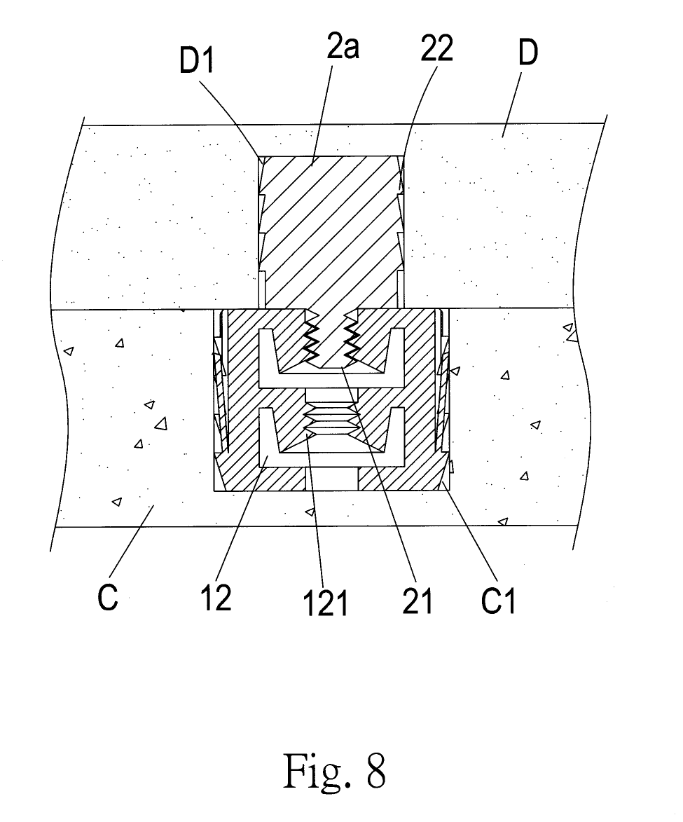

Referring to FIG. 8, a second embodiment of the present invention is illustrated. The components and the operation is pretty much the same as the first embodiment. The difference is the embodiment has a short bolt 2a. Through the first and the second embodiments, it is obvious that any kind of bolt can be applied to the present invention.

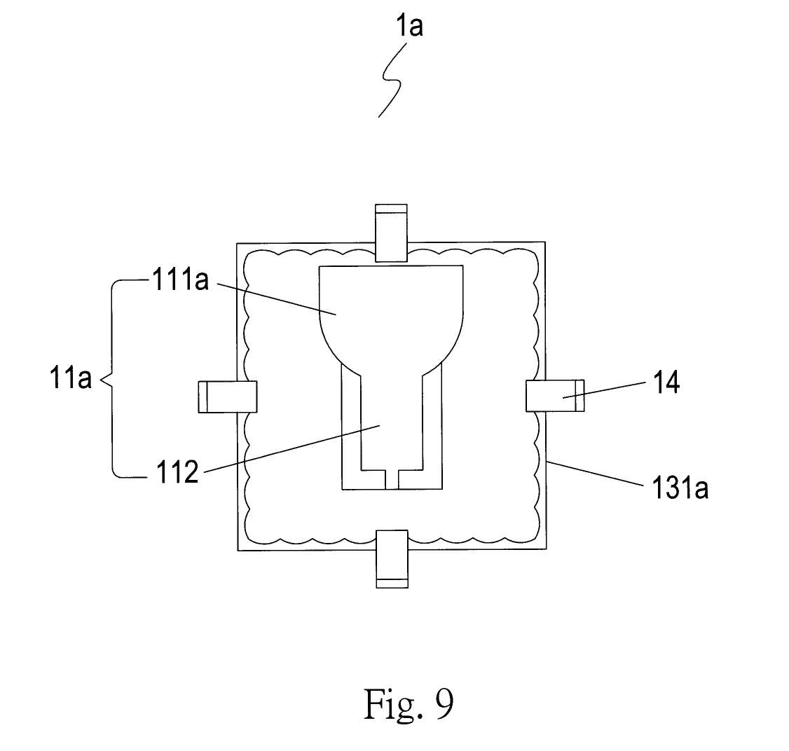

Referring to FIG. 9, a third embodiment of the present invention is illustrated. The components and the operation is pretty much the same as the first embodiment. The difference is that a main body 1a and teeth 131a of the embodiment are rectangular. A bolt hole 11a and an open hole 111a are U-shaped. The shapes of the main body 1a, teeth 131a, and the open hole 111a can be varied depending on the needs. For example, the main body 1a can be circular, oval-shaped, or polygonal, and the open hole 111a can be U-shaped, circular, rectangular, or polygonal.

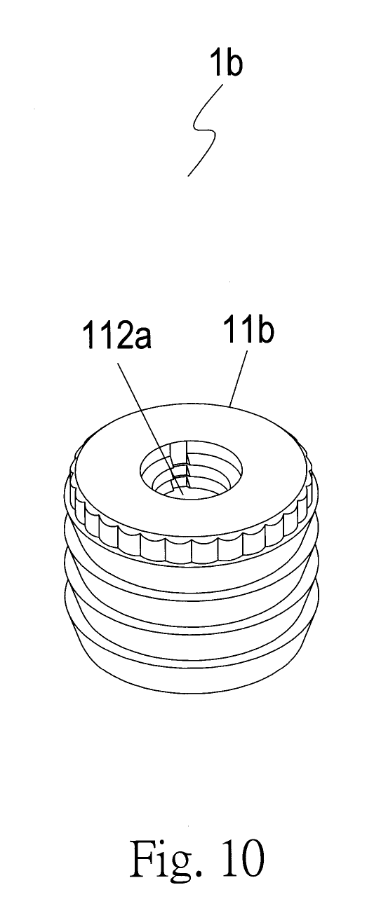

Referring to FIG. 10, a fourth embodiment of the present invention is illustrated. The components and the operation is pretty much the same as the first embodiment. The difference is that a main body 1b and a bolt hole 11b is circular. The bolt hole 11b contains a positioning hole 112a. The bolt 2 can be directly put into the bolt hole 11b for being positioned.

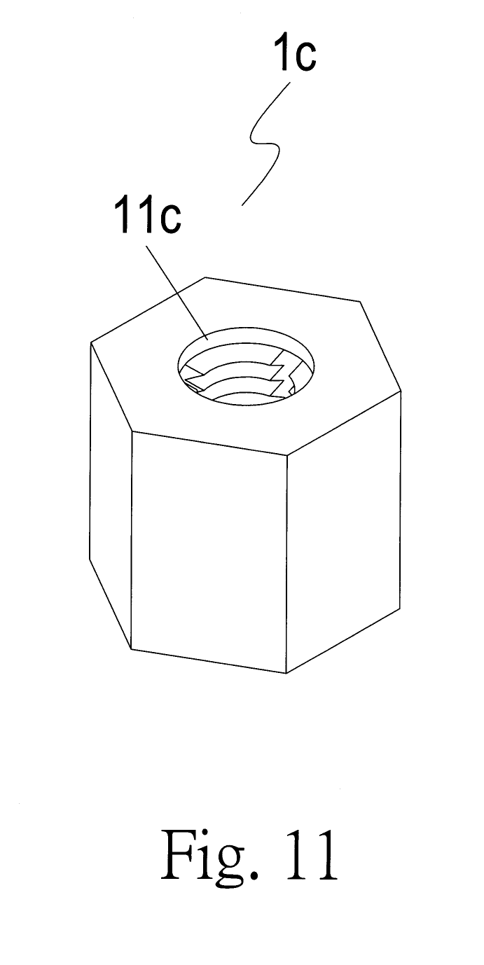

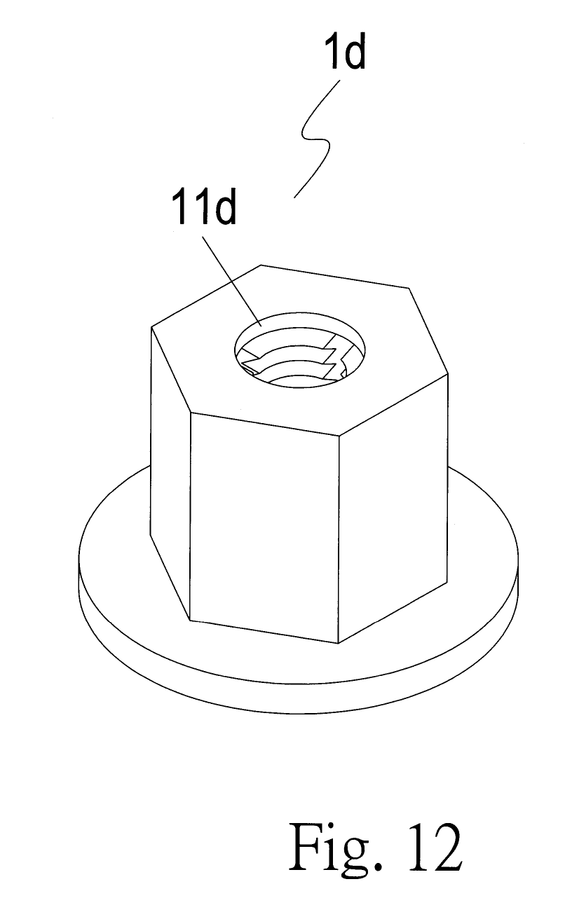

Referring to FIGS. 11 and 12, a fifth and a sixth embodiments are illustrated respectively. The components and the operation is pretty much the same as the first embodiment. The difference is that the main body 1c and 1d are formed as a nut for replacing a prior nut. While assembling, bolts 1c and 1d are directly put into bolt holes 11c and 11d of the main bodies 1c and 1d respectively. While disassembling, the bolts can be removed from the main bodies by rotating the bolts. The operation is simple and quick, and the connection is secure.

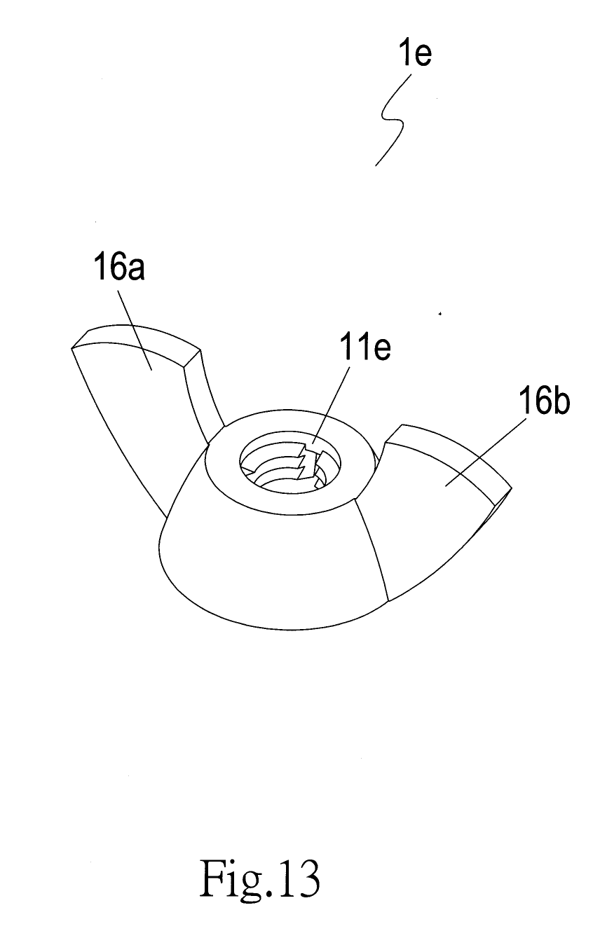

Referring to FIG. 13, a seventh embodiment of the present invention is illustrated. The components and the operation is pretty much the same as the firth embodiment. The difference is that the main body 1e is formed as a nut. Two ears 16a and 16b are formed to two opposite sides of the main body 1e for handling. User can twist the main body le through the ears to position the main body 1e. A bolt 2 can be directly put into a bolt hole 11e for assembling.

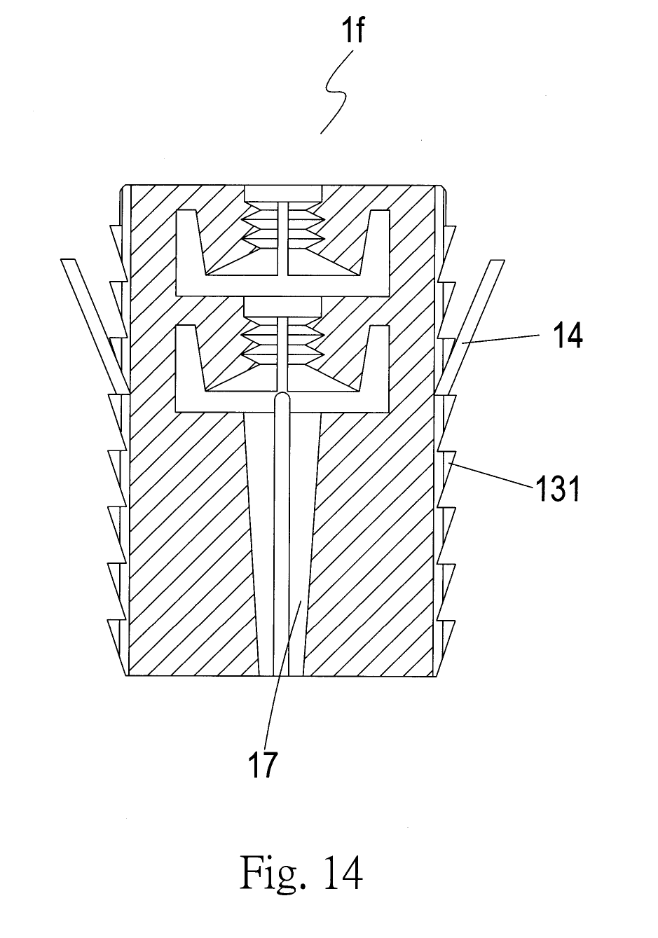

Referring to FIG. 14, a eighth embodiment of the present invention is illustrated. The components and the operation is pretty much the same as the first embodiment. The difference is that a main body if of the eighth embodiment can be applied to a concrete plate. The main body 1f of the embodiment has a tunnel 17 connected to a bolt hole. The tunnel 17 is getting smaller towards a bottom of the main body. While a bolt 2 is put into the bolt hole of the main body 1f, the main body 1f will be expanded as the bolt going further in the tunnel 17 so that the main body 17 will be securely fixed in the concrete plate.

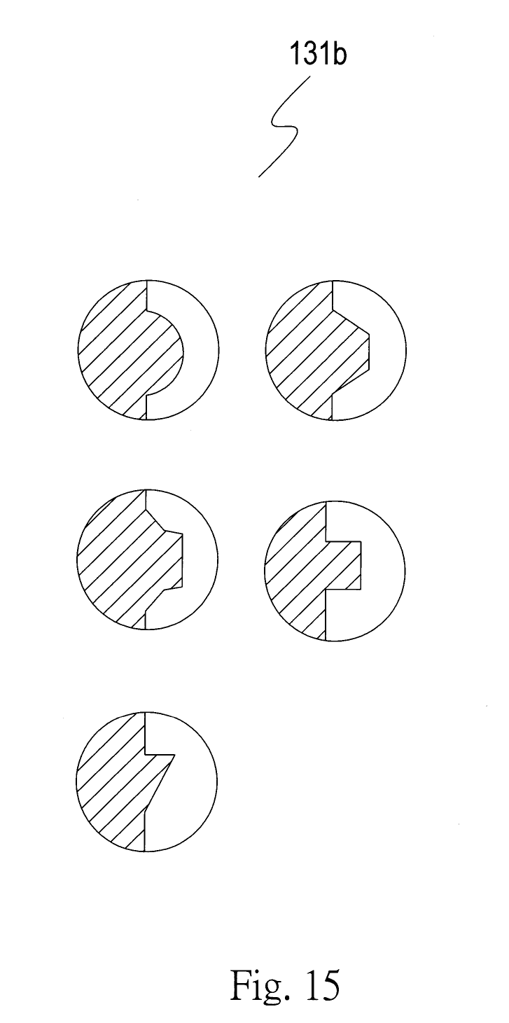

Referring to FIG. 15, various types of tooth are illustrated. The different types of the tooth 131b such as curved, trapezoid, triangular, or polygonal tooth can be applied to different usages. It can be formed as other shape depending on the needs.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A furniture connector comprising:
a main body having a bolt hole for receiving a bolt;
the bolt having a positioning portion and a connecting portion; the positioning portion being received by the bolt hole of the main body;
wherein the bolt hole is vertically extended from a top to a bottom of the main body; the positioning hole further has at least one expanding chamber radially extending from the wall of the positioning hole; at least one tooth is formed to the a wall of the expanding chamber to engage the positioning portion of the bolt; the main body and the bolt are inserted into a first recess and a second recess of furniture plates respectively.

2. The furniture connector as claimed in claim 1, wherein a saw-toothed surface is formed to an outer surface of the main body; the saw-toothed surface has a plurality of teeth.

3. The furniture connector as claimed in claim 2, wherein the saw-toothed surface has at least one pair of elastic bar and at least one pair of positioning mark.

4. The furniture connector as claimed in claim 2, wherein each tooth is formed as one of a curve, triangle, trapezoid, or polygon.

5. The furniture connector as claimed in claim 1, wherein the bolt hole includes an open hole and a positioning hole.

6. The furniture connector as claimed in claim 5, wherein the open hole can be one of a U-shaped, fan-shaped, circular, rectangular, or polygonal hole.

7. The furniture connector as claimed in claim 1, wherein the bolt hole constains a positioning hole.

8. The furniture connector as claimed in claim 1, wherein a surface of the connecting portion of the bolt is saw-toothed for engaging the second recess of the plate.

9. The furniture connector as claimed in claim 1, wherein the main body is formed as one of a circle, ellipse, rectangle, or a polygon.
